(19) United States
(12) Patent Application Publication
(10) Pub. No.: US 2016/0367908 A1
(43) Pub. Date: Dec. 22, 2016

(54) SEPARATION COLUMN HAVING AN INTERNAL HEAT EXCHANGER

(71) Applicant: UOP LLC, Des Plaines, IL (US)

(72) Inventor: Zhanping Xu, Inverness, IL (US)

(21) Appl. No.: 15/145,649

(22) Filed: May 3, 2016

Related U.S. Application Data
(60) Provisional application No. 62/182,984, filed on Jun. 22, 2015.

(51) Int. Cl. B01D 3/00; F28D 15/00; F28F 3/02

(52) U.S. Cl. CPC B01D 3/007; F28F 3/027; F28D 15/00

(57) ABSTRACT

A separation column and a process for using same to separate a hydrocarbon or chemical mixture into at least a vapor stream and a liquid stream. The separation column includes an internal heat exchanger. The heat exchanger has a plurality of fins which allow for heat and mass transfer by including apertures. The fins may include louvers or perforations associated with the apertures to increase radial flow and permit fluids to flow through the fins. The heat exchanger may be used to supply heat to the column, remove heat from the column, or both.

### CROSS-REFERENCE TO RELATED APPLICATION

This application claims priority from Provisional Application No. 62/182,984 filed Jun. 22, 2015, the contents of which are hereby incorporated by reference.

### FIELD OF THE INVENTION

This invention relates generally to a separation column having an internal heat exchanger, and more particularly to the design of such heat exchangers in a separation column.

### BACKGROUND OF THE INVENTION

Petroleum refining and petrochemical processes frequently involve the separation of components of a stream within a separation column, such as a fractionation or distillation column. It has been suggested to incorporate one or more heat exchangers into these types of separation columns. For example, U.S. Pat. No. 8,881,549 discloses a separation column that includes a heat exchange means within the separation column that is used to exchange heat between a heating or cooling medium and a fluid stream in the separation column.

By placing heat exchangers inside of the separation column, for example as a bottom reboiler, a side reboiler, a top condenser, or a side condenser, the resulting separation system will require less plot space, less piping, and fewer connections and foundations are needed. While these advantages for a separation column with internal heat exchangers are beneficial in a land based operation, these advantages are especially desirable in offshore applications. Therefore, such separation columns may be utilized in a variety of different processing applications.

Radial flow distribution in packed columns is critical for correcting fluid mal-distribution and maintaining uniform compositions across the radial direction for achieving the expected mass transfer efficiency. Tube-fin heat exchanger are one type of heat exchanger that have been suggested to be utilized in the separation columns. However, the conventional tube-fin exchangers do not provide this critical function, which can be detrimental for the product purity and recovery.

While the fin plates enhance heat transfer and also provide vapor-liquid contact area for mass transfer, the existing tube-fin exchangers use vertical solid plates as fins. Since the fluids for both mass transfer and heat exchange are on the fin side of the heat exchanger, the vertical solid plates provide little radial fluid flow within the vertical channels between the vertical plates and do not permit radial fluid flow across the vertical plates. Thus, the vertical solid plates provide little radial fluid flow in the tube-fin heat exchanger. As mentioned above, this can be detrimental for the product purity and recovery.

Therefore, there remains a need for an effective and efficient process and design which allows for the use of a heat exchanger within a separation column in which the heat exchanger allows for radial flow of fluids.

### SUMMARY OF THE INVENTION

A separation column having an internal heat exchanger and a process for adding heat, removing heat, or both from such a separation column have been invented.

In a first aspect of the present invention, the present invention may be characterized broadly as providing a separation column for separating components of a fluid stream. In various embodiments, the separation column comprises: a body having a top and a bottom; a first outlet proximate the top of the body and configured to provide a gaseous stream; a second outlet proximate the bottom of the body and configured to provide a liquid stream; at least one heat exchanger disposed within the body between the vapor outlet and the liquid outlet; and, an inlet disposed between the first outlet and the second outlet. The heat exchanger preferably has an inlet for a heat transfer fluid, an outlet for the heat transfer fluid, at least one conduit between the inlet and the outlet, and a plurality of fins extending away from the at least one conduit.

In various embodiments of the present invention, the fins of the at least one heat exchanger are disposed so as to create channels that are parallel to a normal axis of the separation column. It is contemplated that a surface of the fins include a plurality of louvers configured to create a flow of fluids at an angle to the normal axis of the separation column. It is also contemplated that at least some of louvers comprise punched louvers.

In some embodiments of the present invention, the fins of the at least one heat exchanger are disposed so as to create channels that are at an angle to a normal axis of the separation column. It is contemplated that a surface of the fins of such a heat exchanger include a plurality of louvers. It is also contemplated that at least some of louvers comprise punched louvers. It is alternatively contemplated that a surface of the fins of such a heat exchanger include a plurality of perforations. It is also further contemplated that a surface of the fins of such a heat exchanger include a plurality of punched louvers and perforations.

In at least one embodiment of the present invention, the separation column further includes a mass transfer device disposed inside of the body between the first outlet and the second outlet.

In one or more embodiments of the present invention, the at least one heat exchanger is disposed below the inlet and is configured as a heating element configured to supply heat to the separation column.

In at least one embodiment of the present invention, the at least one heat exchanger is disposed above the inlet and is configured as a cooling element configured to remove heat from the separation column.

In some embodiments of the present invention, the separation column includes two or more heat exchangers, each disposed within the body between the first outlet and the second outlet, and each heat exchanger having an inlet for a heat transfer fluid, an outlet for the heat transfer fluid, at least one conduit between the inlet and the outlet, and a plurality of fins extending away from the at least one conduit. A first heat exchanger is preferably disposed above the inlet and a second heat exchanger is preferably disposed below the inlet.

In many embodiments of the present invention, a difference between a temperature at the vapor outlet and at the liquid outlet is greater than 20° C.

In a second aspect of the present invention, the invention may be generally characterized as providing a process for separating components of a fluid stream by: passing a feed stream to a separation column configured to separate the feed stream into at least one gaseous component and at least one liquid component, passing a heat transfer fluid to the inlet of the at least one heat exchanger; recovering a heat transfer fluid from the outlet of the at least one heat exchanger, a temperature of the heat transfer fluid at the outlet being different than a temperature of the heat transfer fluid at the inlet; recovering a gaseous stream from the vapor outlet, the gaseous stream comprising the gaseous components; and, recovering a liquid stream from the liquid outlet, the liquid stream comprising the liquid components. The separation column preferably comprises a body having a top and a bottom; a vapor outlet proximate the top of the body; a liquid outlet proximate the bottom of the body and configured; at least one heat exchanger disposed within the body between the vapor outlet and the liquid outlet; and, an inlet for the feed stream disposed between the vapor outlet and the liquid outlet. Most preferably the heat exchanger comprises an inlet, an outlet, at least one conduit between the inlet and the outlet, and a plurality of fins extending away from the at least one conduit.

In various embodiments of the present invention, the fins of the at least one heat exchanger are disposed so as to create channels that are parallel to a normal axis of the separation column. It is contemplated that a surface of the fins include a plurality of louvers configured to create a flow of fluids at an angle to the normal axis of the separation column.

In at least one embodiment of the present invention, the fins of the at least one heat exchanger are disposed so as to create channels that are at an angle to a normal axis of the separation column.

In various embodiments of the present invention, the process includes providing heat into the separation column, wherein heat is provided by the heat transfer fluid in the at least one heat exchanger.

In some embodiments of the present invention, the process includes removing heat from the separation column, wherein heat is removed by the heat transfer fluid in the at least one heat exchanger.

In some embodiments of the present invention, the separation column includes two or more heat exchangers, each disposed within the body between the vapor outlet and the liquid outlet, and each heat exchanger having an inlet for a heat transfer fluid, an outlet for the heat transfer fluid, at least one conduit between the inlet and the outlet, and a plurality of fins extending away from the at least one conduit. It is contemplated that a first heat exchanger is configured to provide heat to the separation column, and a second heat exchanger is configured to remove heat from the separation column.

Additional aspects, embodiments, and details of the invention, all of which may be combinable in any manner, are set forth in the following detailed description of the invention.

### BRIEF DESCRIPTION OF THE DRAWINGS

One or more exemplary embodiments of the present invention will be described below in conjunction with the following drawing figures, in which:

FIG. 1 shows a schematic view of a separation column according to one or more embodiments of present invention;

FIG. 2 shows another schematic view of a separation column according to one or more embodiments of the present invention;

FIG. 3 shows a top view of a heat exchanger that may be used in accordance with one or more embodiments of the present invention;

FIG. 4 is an elevated side view of the heat exchanger shown in FIG. 3;

FIG. 5 is an elevated side view of another heat exchanger that may be used in accordance with one or more embodiments of the present invention;

FIG. 6 is a top view of the heat exchanger of FIG. 5 taken along line A-A;

FIG. 7 is a top view of the heat exchanger of FIG. 5 taken along line B-B;

FIG. 8 is an elevated front view of a fin of a heat exchanger that may be used in accordance with one or more embodiments of the present invention;

FIG. 9 is a side view of the fin shown in FIG. 8;

FIG. 10 is an elevated front view of two adjacent fins in a heat exchanger that may be used in accordance with one or more embodiments of the present invention;

FIG. 11 is a side view of the fin configuration shown in FIG. 10;

FIG. 12 is a front view of an exemplary louver that may be used on a fin of a heat exchanger that may be used in accordance with one or more embodiments of the present invention;

FIG. 13 is a top view of the louvers shown in FIG. 12;

FIG. 14 is a cutaway front perspective view of another fin of a heat exchanger that may be used in accordance with one or more embodiments of the present invention; and,

FIG. 15 is a top and side perspective view of a further fin of a heat exchanger that may be used in accordance with one or more embodiments of the present invention.

### DETAILED DESCRIPTION OF THE INVENTION

As mentioned above, a new separation column having an internal heat exchanger and a process for adding heat, removing heat, or both from such a separation column have been invented.

In various embodiments, described in more detail below, the shortcomings of the prior art may be alleviated by providing radial flow through the fins of the heat exchanger by including apertures in the fins. In at least one embodiment, the apertures are associated with louvers which are utilized to create radial flow. By “louvers” it is meant that the apertures are formed with a deformation in the surrounding surface, such as a bent, or the creation of a tab. In some embodiments, the apertures may be associated with perforations. By “perforations,” it is meant that the apertures are openings in which the surround surface of the fins is not altered when the aperture is made. In various embodiments, the fins create channels that are angled with respect to the normal axis of the separation column to provide radial flow to the fluids within the separation column.

For the heat exchangers used in such separation columns, the heat exchangers should be constructed such that the column cross section is mostly, if not all, filled with the exchangers to maximize heat and mass transfer areas. The number of tubes passing through fins at a horizontal cross section depends on the rate or temperature change of heating or cooling fluid flow inside the tubes. The heat exchangers can be constructed with sections and rotated between sections for further improving radial flow distribution. The fluid flow inside the tubes through different horizontal cross sections of the fins should follow the temperature gradient in the separation column. For the heat exchangers in stripping section of the distillation column, hot fluid inside tubes acts as a heating medium and flows up along the heat exchangers. Liquid down in the column on the fin side is partially vaporized. In the rectifying section of the distillation column, the cold fluid inside the tubes acts as cooling medium and flows down along the heat exchangers. In the rectifying section, vapor is partially condensed on the fins of the heat exchangers. Mass transfer occurs with the partial vaporization of lighter components in stripping section and the partial condensation of heavier components in the rectifying section.

With these general principles in mind, one or more embodiments of the present invention will be described with the understanding that the following description is not intended to be limiting.

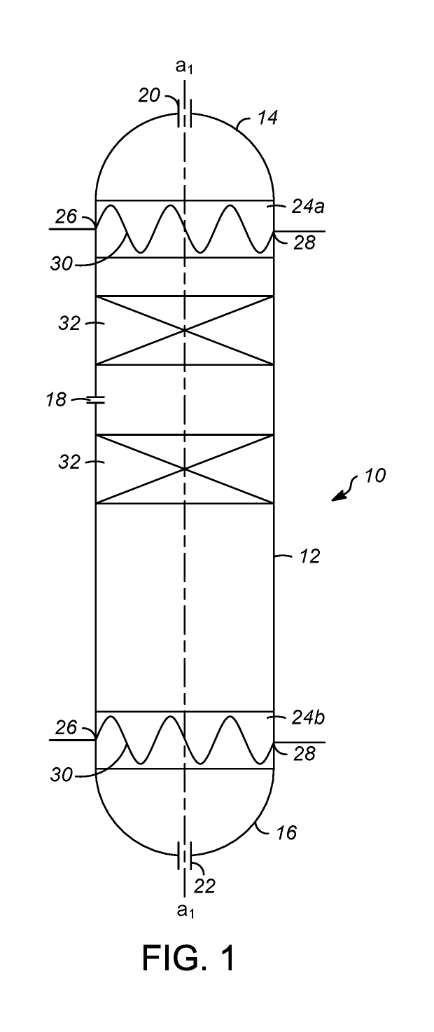

As shown in FIG. 1, an exemplary separation column 10 comprises a body 12 having a top 14 and a bottom 16. A normal axis al-al extends between the top 14 and the bottom 16 of the body 12. Although not depicted as such, some separation columns include a head or other separation device to create two different chambers, one on top of the other, within such separation columns. Additionally, some separation columns utilize a vertical baffle or wall to create two adjacent chambers within such separation columns. These types of columns can be utilized in accordance with the present invention.

Returning to FIG. 1, the separation column 10 typically has at least one inlet 18 for receiving a liquid or vapor or mixed liquid and vapor of a mixture containing hydrocarbons and/or other components to be separated. Although only one inlet 18 is shown, it is contemplated that the separation column 10 includes multiple inlets.

Additionally, the separation column 10 has at least one vapor outlet 20 disposed proximate or near the top 14 of the body 12 for a gaseous or vapor stream. Additionally, the separation column 10 includes at least one liquid outlet 22 disposed proximate the bottom 16 of the body 12 for a liquid stream. The at least one inlet 18 is typically disposed between the vapor outlet 20 and the liquid outlet 22. Although not depicted as such, the separation column 10 many include more than one vapor outlet or liquid outlet such that the separation column 10 provides, many different outlet streams. For example, some separation columns include a sidecut stream taken at a point between the top 14 and the bottom 16 of the body 12. The present invention may be practiced with such columns.

The separation column 10 may have a temperature differential, or a difference between a temperature at the vapor outlet 20 and the liquid outlet 22, that is less than 20° C. Alternatively, the separation column 10 may have a temperature differential that is greater than 20° C. While the present invention is applicable to all types of columns, it is believed that it will be more beneficially used in those separation columns having a temperature differential greater than 20° C. and with heat exchangers in middle of the column because of the ability to use low-grade heating or cooling medium to separate the components in same. However, again, the present invention is not necessarily limited to use in such separation columns.

As shown in FIG. 1, the separation column 10 also includes at least one heat exchanger 24a, 24b disposed within the body 12 between the vapor outlet 20 and the liquid outlet 22. The heat exchanger 24a, 24b may be disposed above the inlet 18 (and thus a condenser) or below the inlet 18 (and thus a reboiler). Preferably, multiple heat exchangers 24a, 24b are used, in which at least one heat exchanger 24a is disposed proximate the top 14 of the body 12 and which is used to remove or recover heat from the fluids in the separation column 10. Additionally, at least one heat exchanger 24b is disposed proximate the bottom 16 of the body 12 and which is used to provide heat to the fluids in the separation column 10. Optionally, additional heat exchangers are disposed between inlet 18 and the heat exchanger 24a and between inlet 18 and the heat exchanger 24b. The cooling medium temperatures for those intermediate heat exchangers above the inlet 18 can be higher than that for the top heat exchanger 24a and the heating medium temperatures for the intermediate heat exchangers can be lower than that for the bottom heat exchanger 24b due to increased temperatures from top to bottom of the column. In other words, low-grade cooling or heating medium can be used for those intermediate heat exchangers, as either condenser or reboiler. Exemplary heat exchangers used in accordance with the present invention are described in more detail below.

Generally, however, each heat exchanger 24a, 24b includes an inlet 26 for a heat transfer fluid, an outlet 28 for the heat transfer fluid and at least one conduit 30 between the inlet 26 and the outlet 28. As should be appreciated, the inlet 26 and the outlet 28 may be formed by openings at the ends of the conduit 30. The conduit 30 is hollow for the passage of the heat transfer fluid from the inlet 26 to the outlet 28. This heat exchanger 24a, 24b may be comprised of a fin and tube type heat exchanger, a plate type heat exchanger, a brazed aluminum type heat exchanger, or other type of heat transfer device, including multi-pass and/or multi-service heat exchangers. For any design of the heat exchanger 24a, 24b, the heat exchanger 24a, 24b is configured to provide heat exchange between any fluid within through the separation column 10 and the heat transfer fluid within the heat exchanger 24a, 24b. Additionally, the heat exchanger will allow for mass transfer between vapor and liquid within the separation column 10 to provide repeatedly partial condensation of the heavy components into downward liquid flow and partial vaporization of the light components into the upward vapor flow in the column.

In addition to the heat exchanger 24a, 24b facilitating mass transfer, the separation column 10 may include one or more mass transfer devices 32, such as structured packing or trays, to allow for contact between the liquid and the vapor in counter-current flow. Some of the mass transfer devices 32 are described in the book DISTILLATION DESIGN by Henry Z. Kister (McGraw-Hill, 1992) and U.S. Pat. No. 7,424,999.

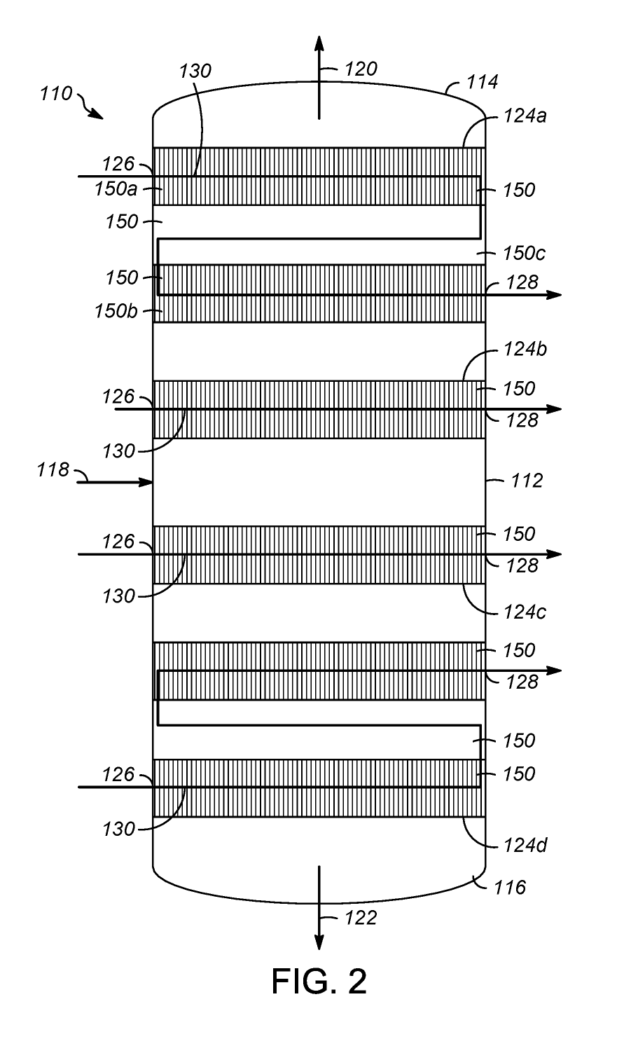

Turning to FIG. 2, another exemplary separation column 110 is shown in which similar elements discussed above are identified with reference numerals that have been increased by 100 compared to FIG. 1. Those portions of the above disclosure relating to these features are incorporated herein by reference.

As shown in FIG. 2, the separation column 110 includes a plurality of heat exchangers 124a, 124b, 124c, 124d. Preferably, each heat exchanger 124a, 124b, 124c, 124d comprises a conduit 130 having an inlet 126 at a first end and an outlet 128 at a second end. The conduit 130 is hollow to allow heat transfer fluid to flow there through. In the heat exchangers 124a, 124b, 124c, 124d, disposed between the inlet 126 and the outlet 128, have a plurality of fins 150 that are in thermal communication with the conduit 130 so as to transfer heat between the fluids flowing between the fins 150 and the heat transfer fluid flowing within the conduit 130.

In the top-most heat exchanger 124a shown in FIG. 2, the heat transfer fluid is used to cool and partially condense the vapors flowing upward in the separation column 110. This particular heat exchanger 124a is depicted as comprising three sets of fins 150, two sets 150a, 150b with the fins 150 extending in a direction in and out of the paper, and a third set 150c of fins 150 (between the other two) extending from left to right across the paper. In this manner, each subsequent set of fins 150 is rotated by 90 degrees around the normal axis of the separation column 110 (if viewed from the top of the separation column 110). In a most preferred embodiment, the temperature profile of the heat transfer fluid in this particular heat exchanger 124a is similar to that of fluid in the separation column 110, in which the inlet 126 is disposed above the outlet 128. Since this heat exchanger 124a is used for partial condensing of the rising vapors, the heat transfer fluid with the higher temperature (at the outlet 128) is disposed lower than the heat transfer fluid with the lower temperature (at the inlet 126).

In the bottom-most heat exchanger 124d shown in FIG. 2, this heat exchanger 124d also comprises three sets of fins 150, with adjacent fins 150 rotated by 90 degrees around the normal axis of the separation column 110 (like the upper most heat exchanger 124a). As this heat exchanger 124d is disposed towards the bottom 116 of the separation column 110, it is used to heat the fluids in the separation column 110 for partial vaporizing of downward flowing liquid. Accordingly, in this heat exchanger 124d, the heat transfer fluid at the inlet 126 will have a higher temperature than the heat transfer fluid recovered from the separation column 110 at the outlet 128 of this heat exchanger 124d.

In contrast to the top-most heat exchanger 124a and the bottom-most heat exchanger 124d, the two middle heat exchangers 124b, 124c shown in FIG. 2 only include one set of fins 150. As should be appreciated, heat exchangers used in accordance with the present invention may have any number of sets of fins.

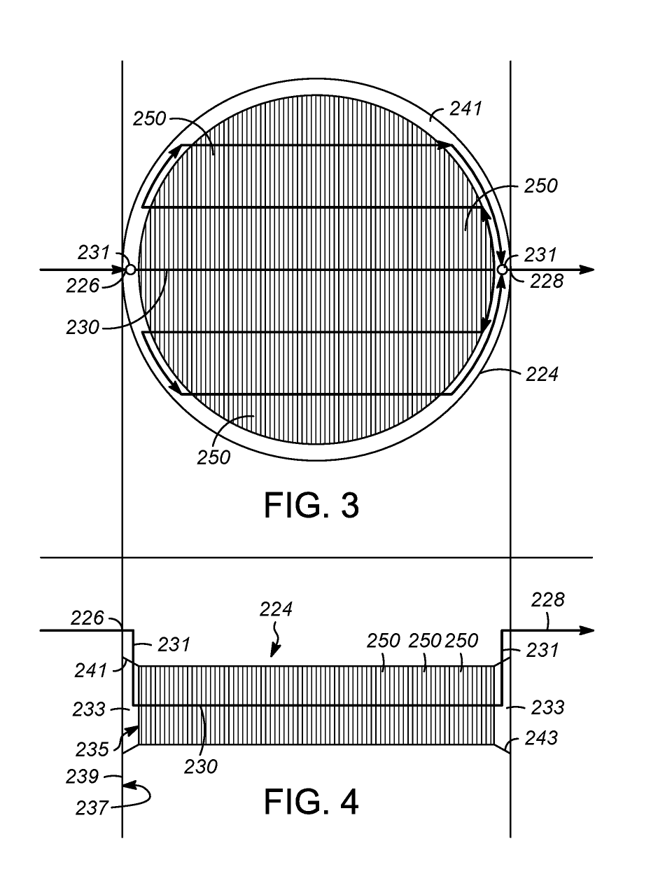

Turning to FIGS. 3 and 4, a heat exchanger 224 is shown in which similar elements discussed above are identified with reference numerals that have been increased by 100 compared to FIG. 2. The heat exchanger 224 has a split flow to ensure that the heating or cooling duty of the fluid within a separation column is distributed as uniformly as possible across the entire heat exchanger 224 cross section. It should be appreciated that this depicted split flow path can be incorporated within any heat exchanger shown herein, including, for example, the heat exchangers 124a, 124b, 124c, 124d shown in FIG. 2.

With reference to FIG. 3, the heat transfer fluid, is split in the conduit 230 after first passing through the fins 250 in a first direction. The heat transfer fluid then travels about the perimeter of the heat exchanger 224 and then passes back through the fins 250 in a direction opposite the direction. After traveling some additional distance about the perimeter of the heat exchanger 224 again, the heat transfer fluid will pass back through the fins 250 in a direction generally the same as the first direction. Thus, the heat transfer fluid makes three passes through the fins 250. It should be appreciated that any number of passes and any number of conduits through the fins 250 may be utilized with the heat transfer fluid being split and combined in, within, and out of the heat exchanger accordingly. Depending on column diameters and heat duty requirement across a cross section, the number of conduits, passes, heat transfer fluid inlets and outlets should be arranged such that the required heat duty is evenly distributed throughout the heat exchanger 224, allowing for more even heat transfer across the cross section of the heat exchanger. Additionally, such an arrangement of conduits 230 across the fins 250 secures the fins 250 of the heat exchanger 224 together. A once-though, or a curvilinear or serpentine flow path with multiple conduits 230 may be used in the heat exchangers described herein. In this case, heat transfer medium is split at inlets and merged at the outlets of the multiple conduits 230 so that only one nozzle on column shell is needed for inlet heat transfer medium and one for outlet heat transfer medium.

As shown in FIGS. 3 and 4, two vertical conduits 231, may be used to connect the inlet 226 and the outlet 231 of the heat exchanger 224 to the conduit 230 in the heat exchanger 224. The vertical conduits 231 may be disposed, at least partially, in an annulus 233 formed between an outer edge 235 of the heat exchanger 224 and an inner surface 237 of a wall 239 of the separation column (such as separation columns 10 or 110, discussed above). A top cover plate 241, or other member, may be disposed on top of the annulus 233 to prevent liquid or vapor from flowing through the annulus 233 and to direct liquid back to the heat exchanger 224. A bottom cover plate 243 may be disposed on the bottom of the annulus to prevent vapors from traveling into the annulus 233; however, the bottom cover plate 243 may not be needed. The annulus 233 may also be sealed by other materials such as ropes.

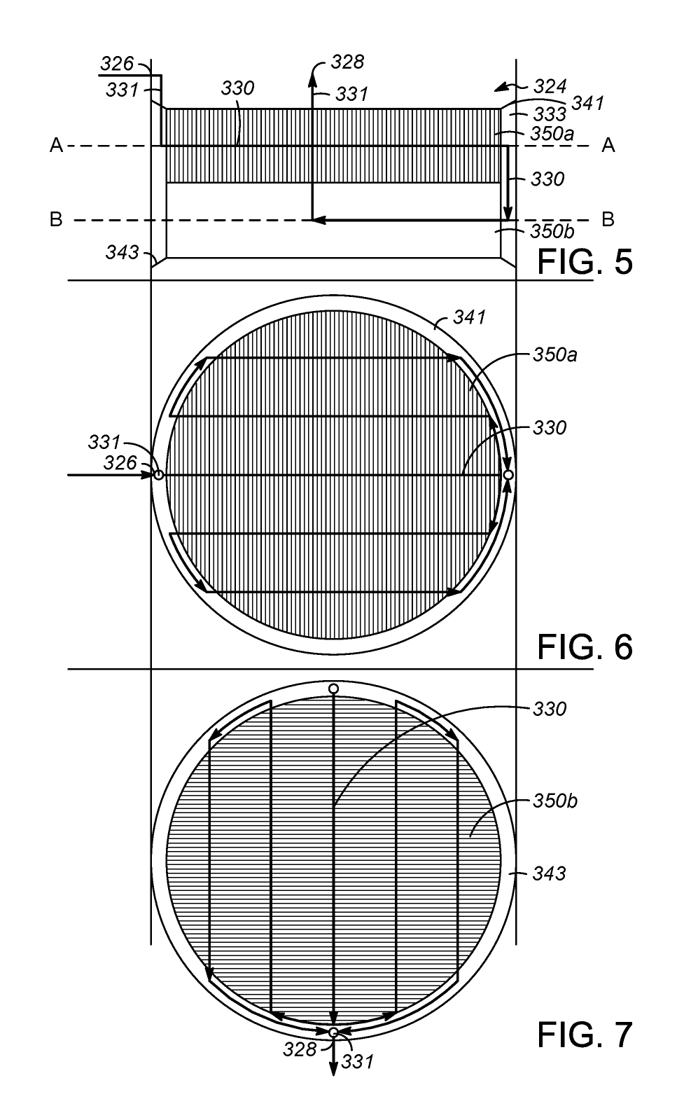

Turning to FIGS. 5 to 7, another heat exchanger 324 is shown in which similar elements discussed above are identified with reference numerals that have been increased by 100 compared to FIGS. 3 and 4. This depicted heat exchanger 324 includes two sets of fins 350a, 350b, with the sets of fins 350a, 350b being rotated by 90 degrees in relation to each other (compare FIG. 6 and FIG. 7). The conduits 330 through the two sets of fins 350a and 350b are also rotated by 90 degrees so that they are perpendicular to the fins. The flow through the two sets of fins 350a, 350b is similar to the flow discussed about with respect to the embodiment shown in FIGS. 3 and 4, and therefore that disclosure is incorporated herein. FIGS. 5 to 7 show that the heat transfer medium flows down from one set of fins to the other, indicating that this is an exemplary internal condenser as discussed above.

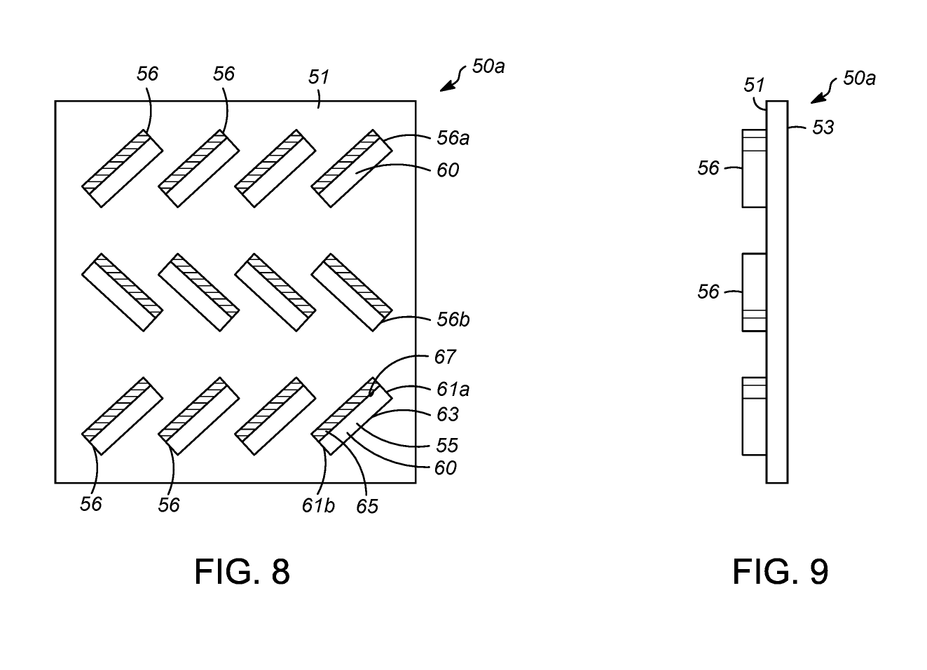

Turning to FIGS. 8 to 10, exemplary fins 50a, 50b are shown which may be used in accordance with a heat exchanger such as those depicted above and discussed here. The fins 50a, 50b comprise flat or relatively planar sheets having a first surface 51 and a second surface 53. In order to increase the mass and heat transfer, it is preferred that the fins 50a, 50b include a plurality of apertures 60 which allow fluids to pass through the fins 50a, 50b. In this depicted embodiment, the apertures are associated with louvers 56, which allow fluids to pass though the fins 50a, 50b and which create a flow of fluids between the fins 50a and 50b at an angle to the normal axis al-al of the separation column, discussed above.

In FIG. 8, the louvers 56 are disposed in rows having alternating angles relative to the normal axis of the column. For example, louvers 56a on the top row of the fin 50a in FIG. 8 extends from the top to the bottom as the louvers 56a extends from right to the left. In contrast, louvers 56b on the middle row extends from the bottom to the top as the louvers 56b extends from right to left. The angled orientation for the louvers 56 increases radial flow, as well as creates non-linear flow paths (meaning the flow paths are not simply straight up and down) through the spaces between adjacent fins 50a, 50b. Additionally, the alternating angles for the rows of louvers 56 ensure that the fluids are evenly distributed, as opposed to being directed in one general direction.

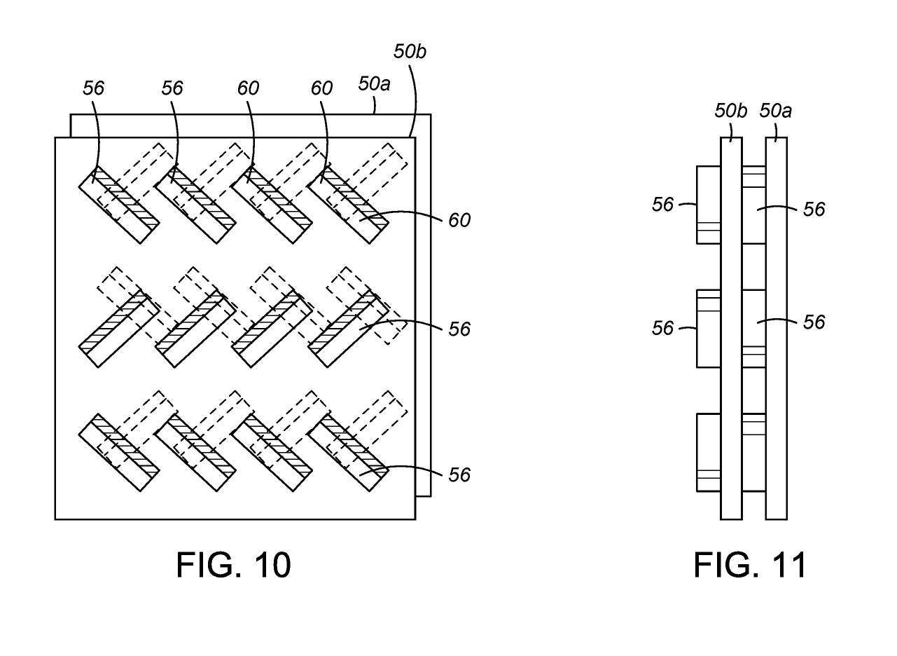

As shown in FIG. 10, adjacent fins 50a, 50b preferably have opposite angled row configurations so that rows that are similarly positioned relative to vertical positioning across adjacent fins 50a, 50b include louvers 56 having opposite, or at least different, angles. In addition to facilitating fluid flow, the louvers 56 can be used as spacers between the adjacent fins 50a, 50b (see FIG. 11).

With refine to FIG. 8, the louver 56 may be made by making two cuts in the fin and comprise the aperture 60 which may be being bounded by two free sides 61a, 61b, a free bottom 63 and a top 65 that is formed by a tab 67 extending away from the fin 50. As will be appreciated, the tab 67 may comprise the material that is punched out of the fins 50. Preferably, the tab 67 extends in a direction that it is generally perpendicular to the surface of the fin 50. It should be appreciated, that the tab 67 could be disposed at the bottom 63 of the aperture 60, or even on one of the sides 61a, 61b of the aperture 60.

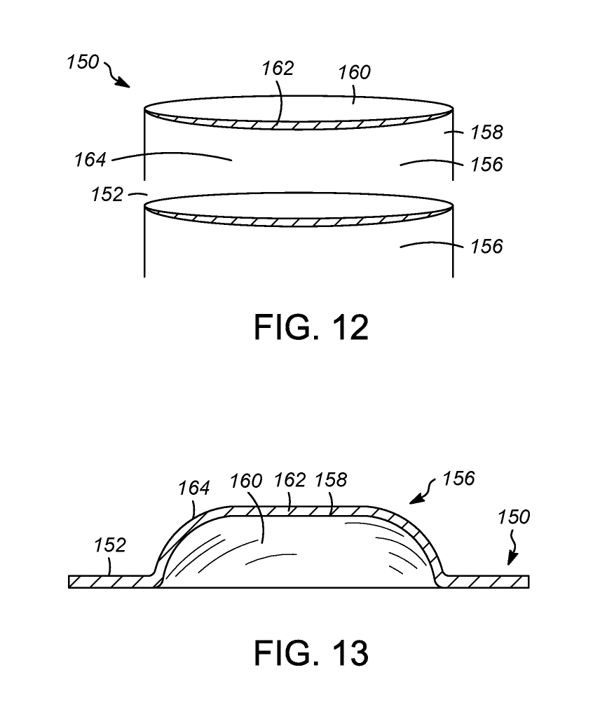

As shown in FIGS. 12 and 13, the louvers 156 may also comprise the aperture 160 and a free edge 162, with a backing surface 164 extending from the free edge 162 back towards the outer surface 152 of the fin 150. Such louvers 156 may be formed by only making a single cut in the fin 150.

The louvers 156 may be orientated with the apertures 160 facing the bottom 16 of the separation column 10. Alternatively, the louvers 156 may be disposed so that apertures 160 are facing the top 14 of the separation column 10. Further, a mixture of the two (opening facing the top 14 and apertures facing the bottom 16) may be used. More preferably, louvers 156 with the apertures being at an angle to the normal axis al-al of the separation column.

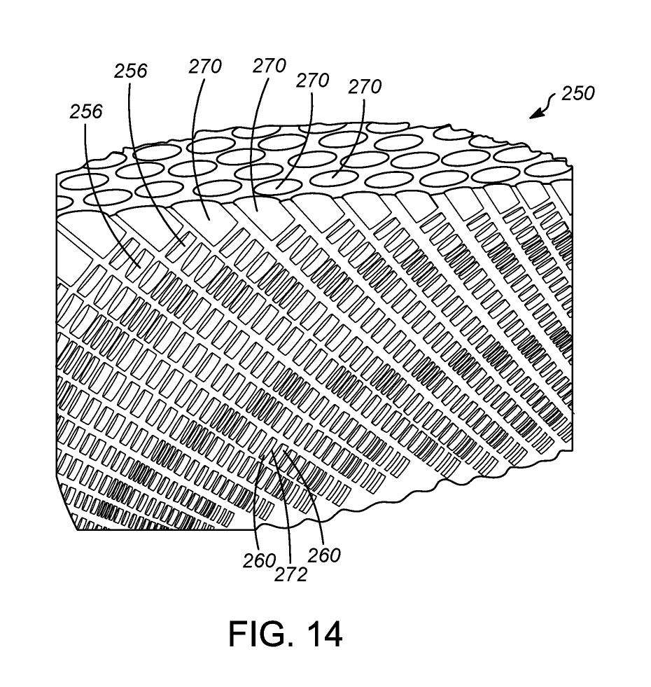

As shown in FIG. 14, the fins 250 of a heat exchanger may be contoured instead of being planar. The depicted fins 250, which are a material similar to Raschig SUPER-PAK structured packing, available from Raschig GmbH Ludwigshafen am Rhein, DE, have flow channels 270 that extend at an angle to the normal axis of the separation column. In a preferred embodiment, the direction of the angle alternatives between adjacent fins 250, for example, right to left from top to bottom for a first fin, and left to right from top to bottom for adjacent fins.

The fins 250 include louvers 256 formed by making two cuts in the surface of the fin 250. These louvers 256 comprise a strip 272 with two oppose sides being integral with the fin 250 and two other opposite sides being bounded by the apertures 260. The strips 272 may be deflected or otherwise bent. In the depicted embodiment, the direction of deflection of the strips 272 (in/out of the paper as shown in FIG. 14) alternates. This is merely preferred. Although not shown, the strips 272 may be rotated to provide a surface that is angled with respect to a surface of the fin 250.

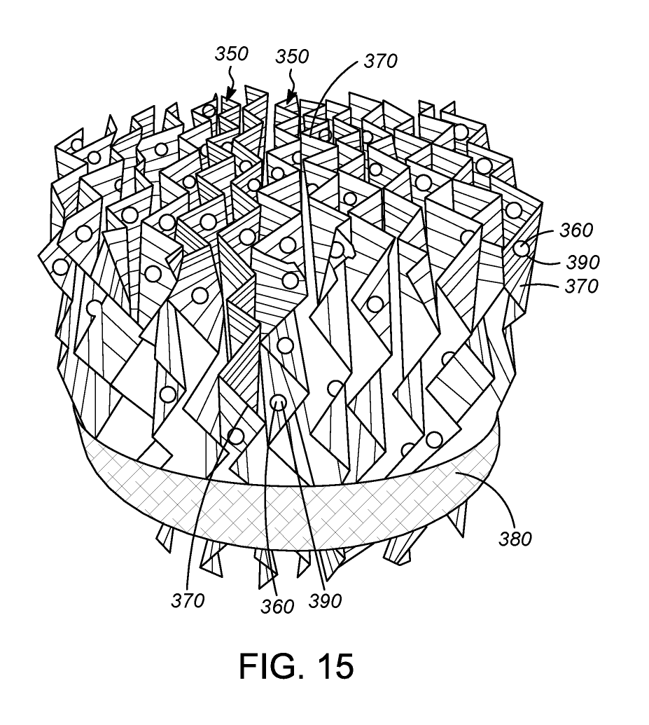

Turning to FIG. 15, another exemplary set of fins 350 is shown in which the fins 350 are comprised of metal corrugated sheeting which may be secured together by conduits through the fins or with a band 380, for example, metal mesh, around the perimeter of the fins. Similar to the previous discussed embodiment, the metal corrugated sheeting includes channels 370 which are preferably at an angle to the normal axis of the separation column and most preferably alternate directions between adjacent fins 350. Additionally, the fins 350 include apertures 360 associated with perforations 390, to allow for fluids to move from one side of the fin 350 to the other side of the fin 350. Furthermore, the perforations 390 could be used on any of the foregoing embodiments.

Conduits preferably pass through the fins perpendicularly. It is also preferred that no louvers or other apertures but holes similar to the outside diameter of the conduits are formed where conduits are passing through. The holes on the fins for conduits to pass through are preferably slightly smaller than the conduit outside diameter so that the fins fit with the conduits tightly for heat transfer between the fins and the conduits and for holding fins together. Wires and metal mesh bands may also be used around the fins to hold them together.

The fin-tube heat exchangers are preferably pre-assembled and loaded into the column from column top. The conduits through the heat exchangers are then connected with nozzles or pipes through nozzles on the column for passing heat transfer medium in and out of the column. The fin-tube heat exchangers may also be assembled inside the column with the components passing through manways on the column shell.

With reference to FIG. 1, an exemplary feed stream comprising different hydrocarbon or chemical components is passed into the separation column 10. The feed stream may be heated or cooled in one or more heat exchange zones before being passed to the separation column 10. Within the separation column 10, vapors will rise and liquid will fall. The surfaces of the heat exchanger 24a, 24b, as well as any mass transfer devices 32, will allow for the vapors and liquids to contact to facilitate the desired separation of the feed stream.

Additionally, a heat transfer fluid is passed into the separation column 10. In the heat exchanger 24a above the inlet 18 (wherein the heat exchanger 24a is used to remove or recover heat from the separation column 10), heat may be transfer from the fluids (vapor and liquid) within the separation column 10 to the heat transfer fluid. A heated heat transfer fluid can be recovered from the outlet 28 of the heat exchanger 24a. As will be appreciated the temperature of the heated heat transfer fluid will be higher than the temperature of the heat transfer fluid provided at the inlet 26 of the heat exchanger 24a. The heated heat transfer fluid may, for example, be passed to another heat exchanger to be used to heat another stream. Alternatively, if the heat transfer fluid is a process fluid, the heated heat transfer fluid can processed further as will be appreciated. For example, the feed stream may comprise the heat transfer fluid passed to a heat exchanger used to recover heat.

For the heat exchanger 24b within the separation column 10 deposed below the inlet 18 (wherein the heat exchanger 24b is used to provide heat to the separation column 10), the heat transfer fluid in the conduit 30 may heat the liquid on the heat exchanger 24b to evaporate some of the light components and provide a cooled heated heat transfer fluid. The cooled heat transfer fluid may be recovered, then heated and reused. In cases where temperatures in the column below the inlet 18 is lower than the feed stream, the feed stream may be used as a heat transfer fluid to heat the fluid in the column and to cool the feed stream.

The various heat exchangers, and modifications and combinations of the various designs may be utilized in the separation column and the process discussed above to ensure appropriate radial flow of fluids and uniform fluid compositions across column cross sections. Additionally, the heat exchangers will provide surfaces for mass transfer allowing the separation column to separate the components of the feed stream. The use of such heat exchangers inside the separation column reduces spaces occupied by equipment and piping between the heat exchangers and the separation column, which is especially beneficially for offshore gas processing plants where space is precious and heat integration is critical for efficient operation of the separation column. The use of multiple heat exchangers in the separation column may lower operating costs by using low-grade heating or cooling medium for intermediate reboilers or condensers in such separation columns.

It should be appreciated and understood by those of ordinary skill in the art that various other components such as valves, pumps, filters, coolers, etc. were not shown in the drawings as it is believed that the specifics of same are well within the knowledge of those of ordinary skill in the art and a description of same is not necessary for practicing or understanding the embodiments of the present invention.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

1. A separation column for separating components of a fluid stream, the separation column comprising:
a body having a top and a bottom;
a vapor outlet proximate the top of the body and configured to provide a gaseous stream;
a liquid outlet proximate the bottom of the body and configured to provide a liquid stream;
at least one heat exchanger disposed within the body between the vapor outlet and the liquid outlet, the heat exchanger having an inlet for a heat transfer fluid, an outlet for the heat transfer fluid, at least one conduit between the inlet and the outlet, and a plurality of fins extending away from the at least one conduit, wherein the fins include a plurality of apertures configured to allow fluids to pass through the fin; and,
an inlet disposed between the vapor outlet and the liquid outlet.

2. The separation column of claim 1, wherein the fins of the at least one heat exchanger are disposed so as to create channels that are parallel to a normal axis of the separation column.

3. The separation column of claim 2, wherein at least one of the apertures in at least one fin each comprise a punched louver.

4. The separation column of claim 3 wherein the punched louvers are angled relative to a normal axis of the separation column.

5. The separation column of claim 1 wherein the apertures in at least one fin of the at least one heat exchanger each comprise louvers, wherein the punched are angled relative to a normal axis of the separation column, and wherein the louvers are disposed in rows having alternating angles relative to the normal axis of the column.

6. The separation column of claim 1, wherein at least one fin of the at least one heat exchanger includes channels that are at an angle to a normal axis of the separation column.

7. The separation column of claim 6, wherein the at least some of the apertures in the fins each comprise a louver.

8. The separation column of claim 7, wherein at least some of louvers comprise punched louvers.

9. The separation column of claim 6, wherein at least some of the apertures in the fins each comprise a perforation.

10. The separation column of claim 6, wherein some of the apertures in at least one fins each comprise a louver and wherein some of the apertures in the at least one fin each comprise a perforation.

11. The separation column of claim 1 wherein the at least one heat exchanger is disposed below the inlet and is configured as a heating element configured to supply heat to the separation column.

12. The separation column of claim 1 wherein the at least one heat exchanger is disposed above the inlet and is configured as a cooling element configured to remove heat from the separation column.

13. The separation column of claim 1 further comprising two or more heat exchangers, each disposed within the body between the vapor outlet and the liquid outlet, and each heat exchanger having an inlet for a heat transfer fluid, an outlet for the heat transfer fluid, at least one conduit between the inlet and the outlet, and a plurality of fins extending away from the at least one conduit, wherein a first heat exchanger is disposed above the inlet and wherein a second heat exchanger is disposed below the inlet.

14. A process for separating components of a fluid stream, the process comprising:
passing a feed stream to a separation column configured to separate the feed stream into at least one gaseous component and at least one liquid component, the separation column comprising a body having a top and a bottom; a vapor outlet proximate the top of the body; a liquid outlet proximate the bottom of the body and configured; at least one heat exchanger disposed within the body between the vapor outlet and the liquid outlet, the heat exchanger having an inlet, an outlet, at least one conduit between the inlet and the outlet, and a plurality of fins extending away from the at least one conduit, wherein the fins include a plurality of apertures configured to allow fluids to pass through the fin; and, an inlet for the feed stream disposed between the vapor outlet and the liquid outlet;
passing a heat transfer fluid to the inlet of the at least one heat exchanger;
recovering a heat transfer fluid from the outlet of the at least one heat exchanger, a temperature of the heat transfer fluid at the outlet being different than a temperature of the heat transfer fluid at the inlet;
recovering a gaseous stream from the vapor outlet, the gaseous stream comprising the at least one gaseous component; and
recovering a liquid stream from the liquid outlet, the liquid stream comprising the at least one liquid component.

15. The process of claim 14, wherein at least one fin of the at least one heat exchanger includes channels that are parallel to a normal axis of the separation column.

16. The process of claim 15, wherein a surface of the apertures in the at least one fin comprise a plurality of louvers.

17. The process of claim 14 further comprising providing heat into the separation column, wherein heat is provided by the heat transfer fluid in the at least one heat exchanger.

18. The process of claim 14 further comprising removing heat from the separation column, wherein heat is removed by the heat transfer fluid in the at least one heat exchanger.

19. The process of claim 14 wherein the separation column includes two or more heat exchangers, each disposed within the body between the vapor outlet and the liquid outlet, and each heat exchanger having an inlet for a heat transfer fluid, an outlet for the heat transfer fluid, at least one conduit between the inlet and the outlet, and a plurality of fins extending away from the at least one conduit.

20. The process of claim 19 wherein a first heat exchanger is configured to provide heat to the separation column, and wherein a second heat exchanger is configured to remove heat from the separation column.
